(19) United States
(12) Patent Application Publication
(10) Pub. No.: US 2026/0145428 A1
(43) Pub. Date: May 28, 2026

(54) LIQUID EJECTION SUBSTRATE, LIQUID EJECTION HEAD, AND METHOD FOR MANUFACTURING LIQUID EJECTION SUBSTRATE

(71) Applicant: CANON KABUSHIKI KAISHA, Tokyo (JP)

(72) Inventors: KAZUHISA OKANO, Tokyo (JP); TAMAKI SATO, Kanagawa (JP)

(21) Appl. No.: 19/396,747

(22) Filed: Nov. 21, 2025

(30) Foreign Application Priority Data
Nov. 25, 2024 (JP) 2024-204671

(51) Int. Cl. B41J 2/14; B41J 2/16; B41J 2/175; B41J 2/18

(52) U.S. Cl. CPC B41J 2/14233; B41J 2/161; B41J 2/164; B41J 2/17596; B41J 2/18; B41J 2002/14306; B41J 2002/14419

(57) ABSTRACT

A liquid ejection substrate includes a plurality of ejection ports, a plurality of pressure chambers, a plurality of energy generation elements, a plurality of individual flow passages, a common flow passage, and a damper film. The plurality of individual flow passages are arranged along a first direction, the common flow passage extends in the first direction, and is configured to supply a liquid in a second direction intersecting the first direction, and a connection portion in which a plurality of connection flow passages configured to supply the liquid in the second direction are arrayed in the first direction is provided in a middle of the common flow passage.

### BACKGROUND

### Field of the Technology

The present disclosure relates to a liquid ejection substrate, a liquid ejection head, and a method for manufacturing a liquid ejection substrate.

### Description of the Related Art

Japanese Patent Laid-Open No. 2000-296616 discloses a printing head (a liquid ejection substrate) including: a plurality of pressure chambers; supply passages (parts of individual flow passages) connected to these pressure chambers, respectively; and one reservoir (part of a common flow passage) connected to the supply passages. According to the printing head of Japanese Patent Laid-Open No. 2000-296616, each supply passage communicating with one end of the corresponding pressure chamber is formed to be shallower than the pressure chamber, so that a constant flow passage resistance of a liquid flowing into the pressure chambers is maintained.

In the printing head of Japanese Patent Laid-Open No. 2000-296616, once the liquid is taken in from one introduction port, the liquid is distributed to the plurality of supply passages via the one reservoir which is connected to the introduction port. Then, the distances from the one introduction port to the plurality of supply passages are different from one supply passage to another.

For this reason, a timing at which the liquid reaches a supply passage which is at a relatively distant position from the introduction port among the plurality of supply passages lags a timing at which the liquid reaches a supply passage which is at a relatively close position to the introduction port. In the case where the liquid cannot be distributed to the plurality of supply passages uniformly at the same timing, there is a possibility that an ejection performance of the liquid in the liquid ejection substrate is affected.

### SUMMARY

The present disclosure is to provide a liquid ejection substrate which can uniformly distribute a liquid to a plurality of individual flow passages.

A liquid ejection substrate includes: a plurality of ejection ports; a plurality of pressure chambers configured to store a liquid to be ejected by the plurality of ejection ports, respectively; a plurality of energy generation elements configured to generate energy for ejecting the liquid from the ejection ports; a plurality of individual flow passages configured to supply the liquid to the plurality of pressure chambers, respectively; a common flow passage configured to supply the liquid to the plurality of individual flow passages in common; and a damper film provided in such a manner as to face part of the common flow passage, wherein the plurality of individual flow passages are arranged along a first direction, the common flow passage extends in the first direction, and supplies the liquid in a second direction intersecting the first direction, and a connection portion in which a plurality of connection flow passages configured to supply the liquid in the second direction are arrayed in the first direction is provided in a middle of the common flow passage.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic perspective view of a liquid ejection apparatus;

FIG. 2 is a diagram for explaining a liquid ejection head;

FIG. 3 is a cross-sectional view taken along solid line III-III of FIG. 2;

FIG. 4 is an enlarged view of a vicinity of an ejection port in FIG. 3;

FIG. 5 is an exploded perspective view of a cross-sectional region A shown in FIG. 4;

FIG. 6A to 6Q are diagrams showing an example of a method for manufacturing a liquid ejection substrate;

FIG. 7A to 7K are diagrams showing an example of a method for manufacturing a liquid ejection substrate;

FIG. 8 is an enlarged view of a vicinity of an ejection port applicable to an embodiment;

FIG. 9 is an exploded perspective view of a cross-sectional region B shown in FIG. 8;

FIG. 10 is an enlarged view of a vicinity of an ejection port applicable to an embodiment;

FIG. 11 is an exploded perspective view of a cross-sectional region C shown in FIG. 10;

FIG. 12 is an enlarged view of a vicinity of an ejection port applicable to an embodiment;

FIG. 13 is an exploded perspective view of a cross-sectional region D shown in FIG. 12;

FIG. 14 is an enlarged view of a vicinity of an ejection port applicable to an embodiment;

FIG. 15 is an exploded perspective view of a cross-sectional region E shown in FIG. 14; and

FIG. 16 is an exploded perspective view of a liquid ejection substrate applicable to an embodiment.

### DESCRIPTION OF THE EMBODIMENTS

### First Embodiment

### Liquid Ejection Apparatus 100

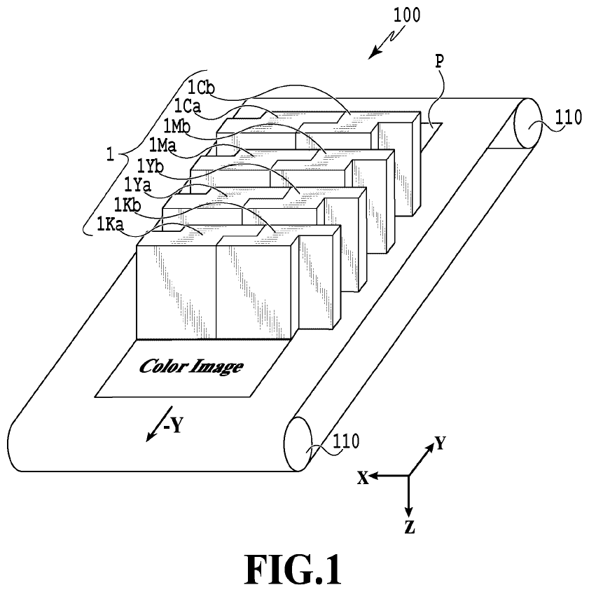

FIG. 1 is a schematic perspective view of a liquid ejection apparatus 100 applicable to the present embodiment. In the present embodiment, an inkjet head is employed as a preferred case of a liquid ejection head 1.

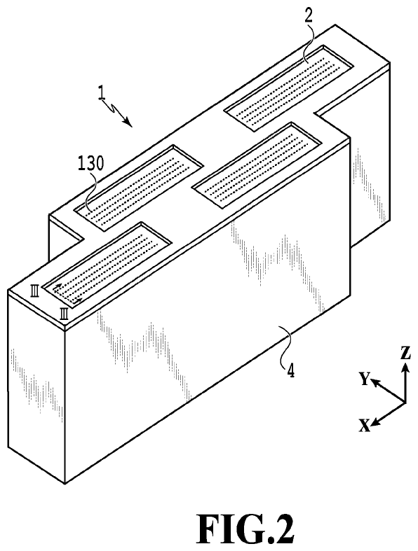

As shown in FIG. 1, the liquid ejection apparatus 100 includes: a conveyance unit 110 configured to convey a printing medium P in a conveyance direction (a direction indicated by −Y); and liquid ejection heads 1 of one pass-type configured to move the printing medium P at once and print an image on the printing medium P. The liquid ejection heads 1 have a width longer than the width of the printing medium P (the length in an X-direction). A plurality of ejection ports 130 (see FIG. 2 and the like) are formed along a width direction of the liquid ejection head 1 (the X-direction). One ejection port array is formed by these ejection ports 130.

In the present embodiment, the liquid ejection heads 1 are capable of ejecting liquids (for example, inks) of four colors of cyan, magenta, yellow, and black from the ejection ports 130.

To eject the ink of cyan, the liquid ejection heads 1 include a first liquid ejection head 1Ca and a second liquid ejection head 1Cb which correspond to the ink of cyan. To eject the ink of magenta, the liquid ejection heads 1 include a third liquid ejection head 1Ma and a fourth liquid ejection head 1Mb which correspond to the ink of magenta. To eject the ink of yellow, the liquid ejection heads 1 include a fifth liquid ejection head 1Ya and a sixth liquid ejection head 1Yb which correspond to the ink of yellow. To eject the ink of black, the liquid ejection heads 1 include a seventh liquid ejection head 1Ka and an eighth liquid ejection head 1Kb which correspond to the ink of black.

The printing medium P is conveyed in the conveyance direction (the −Y-direction) by the conveyance unit 110, and printing is performed on the printing medium P by the liquid ejection heads 1.

Note that the example of the liquid ejection apparatus 100 is not limited to the above-mentioned example. For example, the liquid ejection apparatus 100 may be configured such that liquid ejection heads 1 of any form can be mounted on the liquid ejection apparatus 100. As other examples, the liquid ejection apparatus 100 may include a liquid ejection head 1 of one type, or may include liquid ejection heads 1 of many types other than four types.

### Liquid Ejection Head 1

FIG. 2 is a diagram for explaining the liquid ejection head 1 applicable to the present embodiment. FIG. 2 shows a perspective view of one liquid ejection head 1 configured to eject an ink of any one color among the eight liquid ejection heads 1 shown in FIG. 1. In the drawings, the X-direction is a longitudinal direction of the liquid ejection head 1, and is an array direction of the plurality of ejection ports 130. Hereinafter, the X-direction is also referred to as a first direction. The Y-direction is a transverse direction of the liquid ejection head 1, and the printing medium P is conveyed in the −Y-direction. Hereinafter, the Y-direction is also referred to as a second direction. The Z-direction is a direction in which the liquid is ejected from the plurality of ejection ports 130.

As shown in FIG. 2, the liquid ejection head 1 includes a head main body 4. The head main body 4 includes a plurality of (in the present embodiment, four) liquid ejection substrates 2. In each of the plurality of liquid ejection substrates 2, the plurality of ejection ports 130 are formed.

The ink to be ejected from the liquid ejection head 1 is supplied from an ink tank (not shown) to the liquid ejection substrates 2 via a common supply port (not shown) of the head main body 4. In the liquid ejection substrates 2, the plurality of ejection ports 130 which are formed in an end portion in the X-direction are provided in such a manner as to be placed over one another along the Y-direction. By providing the liquid ejection substrates 2 in this way, printing with long ejection port arrays can be achieved.

### Liquid Ejection Substrate 2

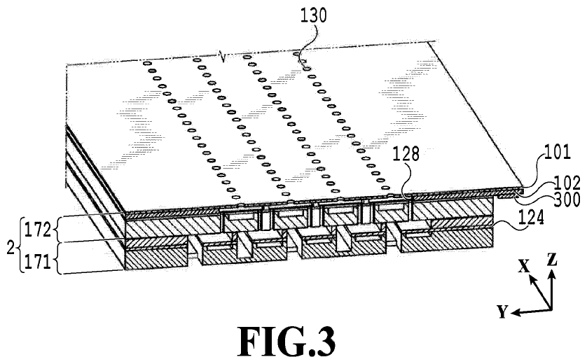

FIG. 3 is a cross-sectional view taken along solid line III-III of FIG. 2.

As shown in FIG. 3, the liquid ejection substrate 2 is formed by laminating a plurality of substrates.

The liquid ejection substrate 2 includes: a first laminate 171 which includes a damper film 124 having elasticity; and a second laminate 172 which includes the ejection ports 130. In the second laminate 172, pressure chambers 128 are formed in such a manner as to correspond respectively to the plurality of ejection ports 130 which are formed along the longitudinal direction (the X-direction) of the liquid ejection substrate 2. That is, in the second laminate 172, a plurality of pressure chambers 128 are formed along the longitudinal direction (the X-direction) of the liquid ejection substrate 2.

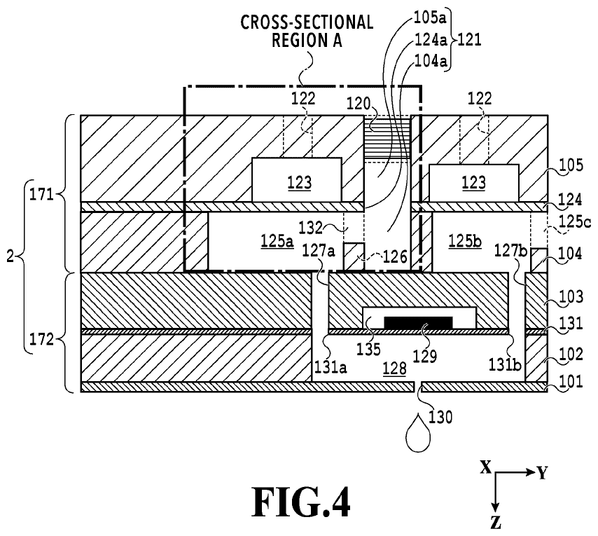

In addition, on a surface, facing in the −Z-direction, of a second substrate 102 included in the second laminate 172, a plurality of common electrodes 300 which are connected to piezoelectric elements 129 (see FIG. 4) are provided. The common electrodes 300 are connected to a drive circuit, which is not shown, via wiring members (for example, flexible cables or the like), which are not shown.

FIG. 4 is an enlarged view of a vicinity of the ejection port 130 in FIG. 3. A liquid ejection mechanism corresponding to one ejection port 130 is shown.

As shown in FIG. 4, the liquid ejection substrate 2 includes: the first laminate 171 in which a plurality of members are laminated; and the second laminate 172 in which a plurality of members are laminated. The second laminate 172 is formed by laminating and fixing (for example, bonding) a first substrate 101, a second substrate 102, a vibration plate 131, and a third substrate 103 in this order. The first laminate 171 is formed by laminating and fixing (for example, bonding) a fourth substrate 104, the damper film 124, and a fifth substrate 105 in this order.

The liquid ejection substrate 2 is formed by fixing (for example, bonding) a lower surface (a surface facing downward in FIG. 4) of the first laminate 171 to an upper surface (a surface facing upward in FIG. 4) of the second laminate 172. In the first laminate 171, a common flow passage which is connected in common to a plurality of individual flow passages individually provided to correspond to the respective ejection ports is formed. This common flow passage includes: an introduction port 120 for introducing the liquid to the liquid ejection substrate 2; a reservoir 121 for allowing the liquid introduced from the introduction port 120 to flow; a connection flow passage 132 which is connected to the reservoir 121; and a first space 125 which is connected to the connection flow passage 132. The first space 125 serves as a common supply flow passage 125a for supplying the liquid to the plurality of pressure chambers 128 in common.

In addition, although not shown in the drawings, in the first laminate 171, the same configuration as the configuration shown in FIG. 4 is provided to flow passages for recovering the liquid. In this way, on the recovery side, the flow passage having the same shape as that of the flow passage shown in FIG. 4 functions as a discharge flow passage, and an introduction port having the same shape as that of the flow passage shown in FIG. 4 functions as a discharge port.

In the present embodiment, the reservoir 121 includes: a first reservoir portion 105a which is formed in the fifth substrate 105; a second reservoir portion 124a which is formed in the damper film 124; and a third reservoir portion 104a which is formed in the fourth substrate 104.

In addition, in the second laminate 172, the ejection port 130 for ejecting the liquid, and an individual flow passage which is connected to the ejection port 130 are formed. Examples of the individual flow passage include an individual supply opening portion 131a, an individual supply flow passage 127a, an individual recovery opening portion 131b, and an individual recovery flow passage 127b.

Note that although not shown in FIG. 4, a plurality of the ejection port 130 and a plurality of the individual flow passages are formed along a depth direction (the X-direction) of FIG. 4. Hereinafter, each of the first substrate 101, the second substrate 102, the third substrate 103, the fourth substrate 104, and the fifth substrate 105 is assumed to be a silicon substrate containing silicon.

In the first substrate 101, the ejection port 130 for ejecting the liquid is formed. The ejection port 130 is formed in such a manner as to penetrate the first substrate 101 in a thickness direction (the Z-direction of FIG. 4) in the state where the first substrate 101 and the second substrate 102 are laminated. The individual supply opening portion 131a and the individual recovery opening portion 131b which penetrate the vibration plate 131 in the thickness direction in the state where the second substrate 102 and the vibration plate 131 are laminated are formed in the vibration plate 131.

The individual supply flow passage 127a and the individual recovery flow passage 127b which penetrate the third substrate 103 in the thickness direction in the state where the vibration plate 131 and the third substrate 103 are laminated are formed in the third substrate 103. Moreover, in the third substrate 103, a housing space 135 for housing an energy generation element which generates energy for ejecting the liquid is formed.

In the present embodiment, a piezoelectric element 129 whose volume is changed by transmission of an electrical signal for ejecting the liquid is used as the energy generation element. The housing space 135 is formed in such a manner as to be depressed from a lower surface of the third substrate 103 toward an upper surface thereof in the state where the vibration plate 131 and the third substrate 103 are laminated.

In the fourth substrate 104, the common supply flow passage 125a, a third reservoir portion 104a, and a common recovery flow passage 125b which penetrate the fourth substrate 104 in the thickness direction in the state where the third substrate 103 and the fourth substrate 104 are laminated are formed. Moreover, in the fourth substrate 104, a connection portion 126 which connects the common supply flow passage 125a and the reservoir 121 is formed.

Note that in the present disclosure, the connection portion is defined to be a portion which connects a certain region and another region via a plurality of flow passages in a supply flow passage for a liquid. In addition, the plurality of flow passages included in the connection portion are referred to as connection flow passages.

In the present embodiment, the connection portion 126 connects the common supply flow passage 125a and the third reservoir portion 104a. The connection portion 126 is formed downstream of the reservoir 121 and upstream of the plurality of individual supply flow passages 127a in a direction of supplying the liquid.

In the connection portion 126, the connection flow passage 132 which connects the common supply flow passage 125a and the reservoir 121 is formed. Note that although not shown in FIG. 4, a plurality of the connection flow passages 132 are formed along the depth direction (the X-direction) of FIG. 4.

Moreover, in the fourth substrate 104, a discharge flow passage 125c for discharging the liquid to the outside of the liquid ejection substrate 2 is formed.

For example, the liquid which has not been ejected from the ejection port 130 passes through the individual recovery opening portion 131b, the individual recovery flow passage 127b, the common recovery flow passage 125b, and the discharge flow passage 125c in this order. Then, the liquid is circulated between the pressure chamber 128 and a circulation pump (not shown) provided outside the liquid ejection substrate 2, and is supplied to the introduction port 120 again. In this way, the common supply flow passage 125a and the common recovery flow passage 125b of the liquid ejection substrate 2 shown in FIG. 4 communicate with the common supply flow passage 125a and the common recovery flow passage 125b of the liquid ejection mechanism (not shown) which is adjacent to the liquid ejection substrate 2 shown in FIG. 4.

In the damper film 124, the second reservoir portion 124a which penetrates the damper film 124 in the thickness direction in the state where the fourth substrate 104 and the damper film 124 are laminated is formed. In the fifth substrate 105, a depressed portion 123 which is depressed from a lower surface of the fifth substrate 105 toward an upper surface thereof in the state where the damper film 124 and the fifth substrate 105 are laminated is formed. Moreover, an air communication port 122 which penetrates the fifth substrate 105 from the deepest portion of the depressed portion 123 toward the upper surface of the fifth substrate 105 is formed. Note that the liquid does not flow through the air communication port 122 and the depressed portion 123.

In the fifth substrate 105, the first reservoir portion 105a which is depressed from the lower surface of the fifth substrate 105 toward the upper surface thereof, and the introduction port 120 which penetrates the fifth substrate 105 from the deepest portion of the first reservoir portion 105a toward the upper surface of the fifth substrate 105 are formed.

Hereinafter, a connection of the flow passages in the present embodiment will be described.

The ejection port 130 is connected to the pressure chamber 128 in the state where the first substrate 101 and the second substrate 102 are laminated.

One end portion (the end portion on the left side in the example of FIG. 4) of the pressure chamber 128 is connected to the individual supply opening portion 131a in the state where the second substrate 102 and the vibration plate 131 are laminated. On the other hand, the other end portion (the end portion on the right side in the example of FIG. 4) of the pressure chamber 128 is connected to the individual recovery opening portion 131b.

The individual supply opening portion 131a is connected to the individual supply flow passage 127a in the state where the vibration plate 131 and the third substrate 103 are laminated. The individual recovery opening portion 131b is connected to the individual recovery flow passage 127b.

The piezoelectric element 129 is provided at a position corresponding to the ejection port 130 (for example, a substantially center of the pressure chamber 128) in the state where the first substrate 101, the second substrate 102, the vibration plate 131, and the third substrate 103 are laminated in this order.

The plurality of individual supply flow passages 127a are connected to one common supply flow passage 125a in the state where the third substrate 103 and the fourth substrate 104 are laminated. Then, the plurality of individual recovery flow passages 127b are connected to one common recovery flow passage 125b.

The third reservoir portion 104a is connected to the second reservoir portion 124a in the state where the fourth substrate 104 and the damper film 124 are laminated.

The second reservoir portion 124a is connected to the first reservoir portion 105a in the state where the damper film 124 and the fifth substrate 105 are laminated.

According to this configuration, the liquid is supplied in the order from the introduction port 120, through the first reservoir portion 105a, the second reservoir portion 124a, the third reservoir portion 104a, the connection flow passage 132, the common supply flow passage 125a, the individual supply flow passage 127a, the individual supply opening portion 131a, and the pressure chamber 128.

In addition, inside the pressure chamber 128, the lower surface of the vibration plate 131 is exposed. The volume of the piezoelectric element 129 is changed by a drive electrical signal being transmitted from a drive circuit (not shown) to the piezoelectric element 129. This causes the pressure inside the pressure chamber 128 to change via the vibration plate 131. This causes the liquid loaded inside the pressure chamber 128 to be ejected as liquid droplets from the ejection port 130.

In addition, the liquid ejection apparatus 100 (see FIG. 1) of the present embodiment is configured to be capable of recovering the liquid which has not been ejected from the ejection port 130. In the case of recovering the liquid, the liquid flows in the order from the pressure chamber 128, through the individual recovery opening portion 131b, the individual recovery flow passage 127b, the common recovery flow passage 125b, and the discharge flow passage 125c, and is discharged to the outside of the liquid ejection substrate 2. The liquid discharged to the outside of the liquid ejection substrate 2 passes through a recovery flow passage, which is not shown, and is returned to the introduction port 120 again by a pump, which is not shown. In this way, the liquid ejection apparatus 100 of the present embodiment is configured to be capable of circulating the liquid between the pressure chamber 128 and the pump, which is not shown.

In addition, in order to perform printing with a higher image quality, there is also a case where the plurality of ejection ports 130 are formed at a high density. In the case where the plurality of ejection ports 130 are formed at a high density, the pressure chambers 128 which are connected to these respective ejection ports 130 are also formed at a high density. Moreover, along with the formation of the pressure chambers 128 at a high density, the common supply flow passages 125a and the introduction ports 120 are also formed at a high density.

As a result, there is a possibility that pressure fluctuation which is generated at the time of ejecting the liquid is transmitted from the pressure chamber 128 to the common supply flow passage 125a and the common recovery flow passage 125b via the individual supply flow passage 127a and the individual recovery flow passage 127b, and is thus transmitted to the pressure chamber 128 of an adjacent liquid ejection mechanism. If pressure fluctuation generated in a certain liquid ejection mechanism is transmitted to an adjacent liquid ejection mechanism, the ejecting operation of the liquid in this liquid ejection mechanism is affected. In view of this, in order to reduce the effect of such pressure fluctuation, the damper film 124 is provided in the liquid ejection substrate 2 of the present embodiment.

In the case where the ejection ports 130 are formed at a high density, the individual supply flow passage 127a shown in FIG. 4 is configured such that an interval with the individual supply flow passage 127a adjacent thereto in the X-direction is narrow. However, since the damper film 124 attenuates pressure fluctuation received from each individual supply flow passage 127a, pressure fluctuation to another individual supply flow passage 127a can be suppressed, and a stable ejecting operation can be performed in each liquid ejection mechanism.

It is preferable that the damper film 124 be a metal thin film or an inorganic thin film in order to attenuate this pressure fluctuation and normalize the ejection of an adjacent liquid ejection mechanism. It is preferable that the thickness of the damper film 124 be 10 μm or less, for example.

In addition, it is preferable that the material of the damper film 124 be a resin having resistance to an organic solvent. Examples of materials applicable to the damper film 124 include polyimide, epoxy, silicon, benzocyclobutene, and the like.

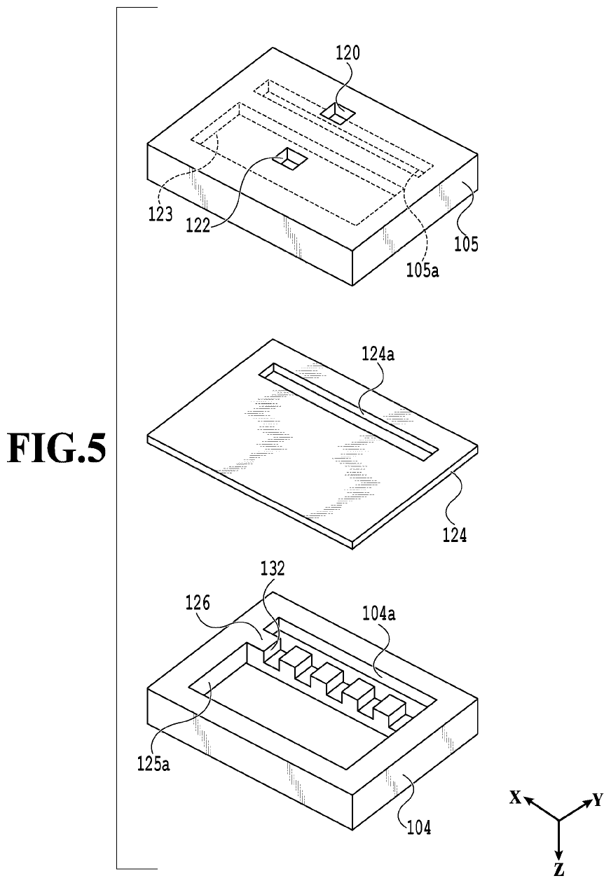

FIG. 5 is an exploded perspective view of a cross-sectional region A shown in FIG. 4.

As shown in FIG. 5, in the fifth substrate 105, the introduction port 120 and the first reservoir portion 105a which is connected to the introduction port 120 and extends along the first direction (the X-direction) are formed. The length, in the first direction, of the first reservoir portion 105a is longer than the length, in the first direction, of the introduction port 120.

In the damper film 124, the second reservoir portion 124a which is connected to the first reservoir portion 105a is formed. The size of an opening of the second reservoir portion 124a is equal to the size of an opening of the first reservoir portion 105a.

In the fourth substrate 104, the third reservoir portion 104a which is connected to the second reservoir portion 124a is formed. The size of an opening of the third reservoir portion 104a is equal to the size of the opening of the second reservoir portion 124a.

That is, the length, in the first direction (the X-direction), of the reservoir 121 (see FIG. 4 and the like) is longer than the length, in the first direction, of the introduction port 120. This makes it possible to spread the flow of the liquid taken in from the relatively small introduction port 120, along the first direction in which the ejection port array extends.

In the fourth substrate 104, the connection portion 126 extends along the first direction. The length, in the first direction, of the connection portion 126 is equal to the length, in the first direction, of the reservoir 121. This configuration makes it possible to maintain the width (the length in the first direction) of the flow of the liquid even in the case where the liquid supplied from the reservoir 121 passes through the connection portion 126.

In the present embodiment, in the connection portion 126, the plurality of connection flow passages 132 are disposed along the first direction. Each of the plurality of connection flow passages 132 extends along the second direction (the Y-direction of FIG. 5) which intersects (specifically, is orthogonal to) the first direction in plane.

Note that the number of the connection flow passages 132 is not limited as long as the number of the connection flow passages 132 is larger than the number of the introduction ports 120. On the other hand, the number of the introduction ports 120 is not limited as long as the number of the introduction ports 120 is smaller than the number of the connection flow passages 132.

The connection portion 126 functions as a supporting portion configured to support the damper film 124 upward from below in the state where the fourth substrate 104 and the damper film 124 are laminated.

In the present embodiment, each of the plurality of connection flow passages 132 is formed in such a manner as to be depressed from the upper surface of the fourth substrate 104 toward the lower surface thereof in this state. Note that in this configuration, although part of the upper surface of the connection portion 126 does not come into contact with the damper film 124, a sufficient bonding area is ensured on the upper surface of the connection portion 126 for fixing the damper film 124.

Moreover, each of the plurality of connection flow passages 132 is formed such that the length thereof in the first direction is shorter than that of one reservoir 121 (the third reservoir portion 104a in the present embodiment).

In addition, each of the plurality of connection flow passages 132 connected to one end portion (the end portion on the right side in the example of FIG. 4) of the common supply flow passage 125a is formed to be shallower than the common supply flow passage 125a. That is, the height (the length in the Z-direction) of the connection flow passage 132 is lower (smaller) than the height (the length in the Z-direction) of the common supply flow passage 125a. Moreover, each of the plurality of connection flow passages 132 is formed such that the length thereof in the first direction is shorter than that of one common supply flow passage 125a.

According to this configuration, when the liquid flows from one third reservoir portion 104a into each of the plurality of connection flow passages 132, the liquid collides with the right surface (the surface facing to the deeper side in the Y-direction in the example of FIG. 5) of the connection portion 126, so that the flow velocity decreases. Then, the flow velocity is made uniform among the plurality of connection flow passages 132 which are disposed along the first direction. This suppresses variation, in the first direction, in the flow velocity of the liquid flowing in the second direction. Then, in the state where such variation in flow velocity in the first direction is resolved, the liquid is supplied from each of the plurality of connection flow passages 132 to one common supply flow passage 125a.

As mentioned above, the plurality of individual flow passages, which are disposed along the first direction, are connected to the downstream side of one common supply flow passage 125a. Since the liquid is supplied to the common supply flow passage 125a in the state where variation in flow velocity in the first direction is resolved, it becomes possible to supply the liquid at substantially uniform flow velocity and flow pressure in each of the plurality of individual flow passages, which are disposed along the first direction.

In addition, as mentioned above, the pressure chamber 128 (see FIG. 4 and the like) is connected to each of the plurality of individual flow passages, and the ejection port 130 (see FIG. 4 and the like) is connected to the pressure chamber 128.

Hence, since the liquid is supplied to each of the plurality of individual flow passages at uniform flow velocity and flow pressure, it becomes possible to supply the liquid to each of the plurality of pressure chambers 128 at uniform flow velocity and flow pressure. In this way, for example, it is possible to suppress a state where the liquid is not ejected (idle ejection) from the ejection ports 130 formed in the end portions in the X-direction.

### First Manufacturing Method

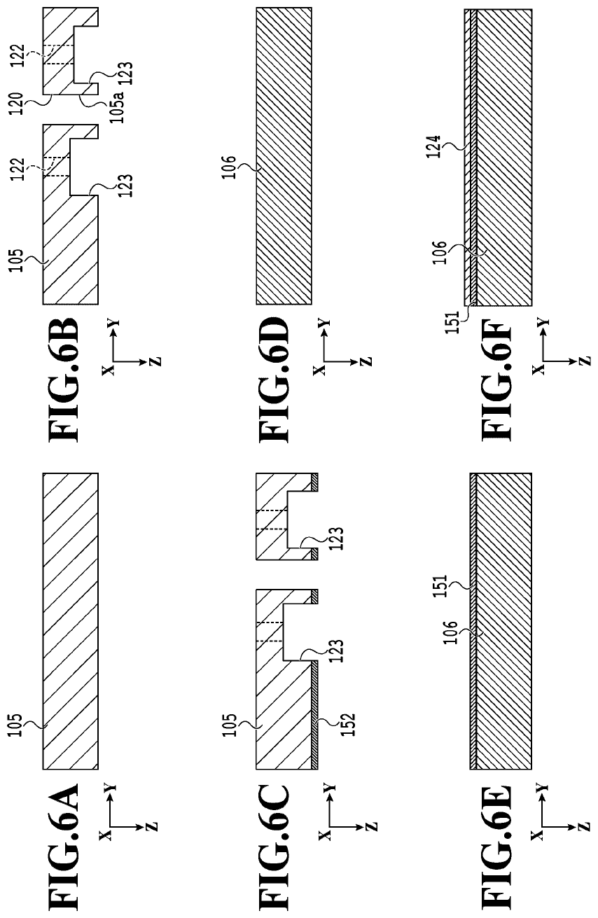

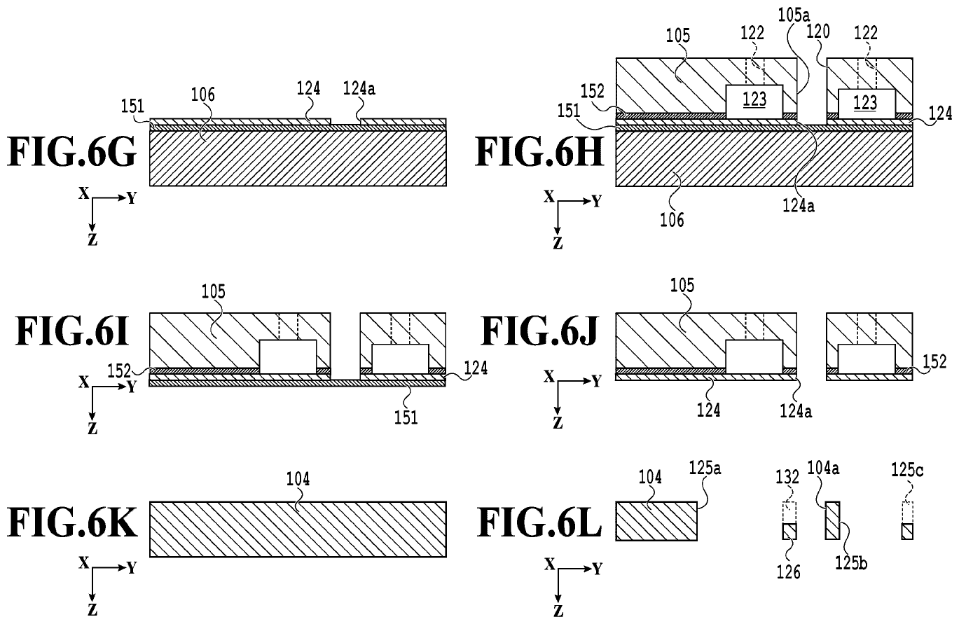

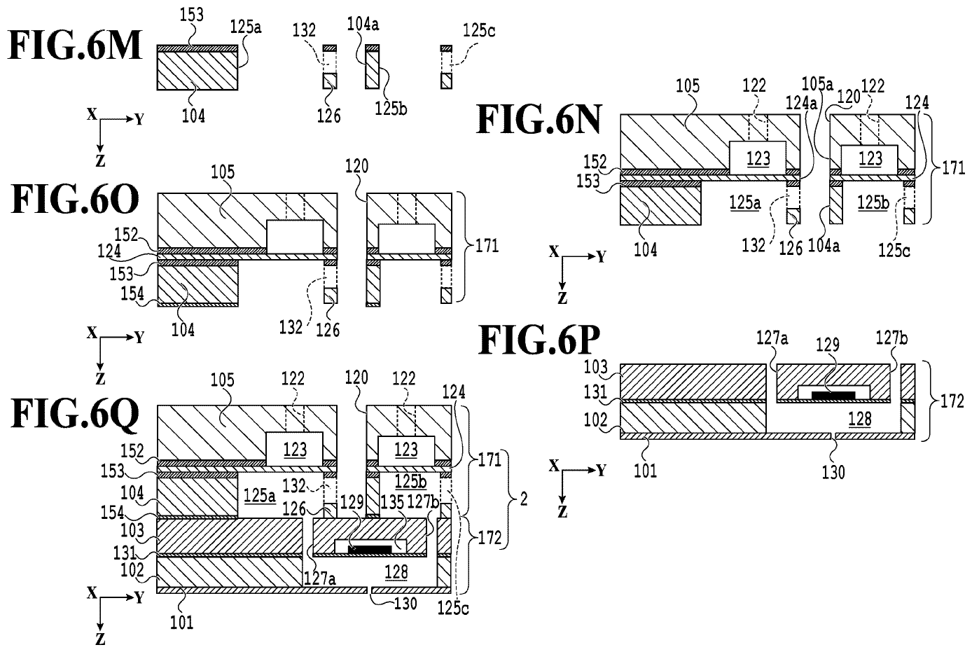

FIG. 6A to FIG. 6Q are diagrams showing an example of a method for manufacturing a liquid ejection substrate 2 applicable to the present embodiment. A surface which faces upward of members shown in FIG. 6A to FIG. 6Q is referred to as an upper surface, and a surface which faces downward thereof is referred to as a lower surface.

As shown in FIG. 6A, a fifth substrate 105 is prepared.

As shown in FIG. 6B, air communication ports 122, an introduction port 120, depressed portions 123, and a first reservoir portion 105a are formed in the fifth substrate 105.

As shown in FIG. 6C, a first adhesive 152 is applied to a lower surface of the fifth substrate 105. However, the first adhesive 152 is not applied to the depressed portions 123.

As shown in FIG. 6D, a supporting substrate 106 for supporting the fifth substrate 105 (see FIG. 6C and the like) is prepared. Note that the supporting substrate 106 is removed in a subsequent step.

As shown in FIG. 6E, an oxide film 151 is formed on an upper surface of the supporting substrate 106. It is preferable that the oxide film 151 contain SiO₂. An example of the oxide film 151 include a thermally oxide film, a CVD oxide film, or the like. Note that the oxide film 151 is removed in a subsequent step.

As shown in FIG. 6F, a damper film 124 is formed on an upper surface of the oxide film 151. For example, the damper film 124 can be formed by processing thermoplastic polyimide into a film shape, and fixing the polyimide to the upper surface of the oxide film 151. In the case of fixing polyimide to the upper surface of the oxide film 151, polyamic acid may be used as a precursor. However, hardening polyamic acid is preferable to processing polyimide into a film shape and fixing the polyimide because the joint strength can be easily enhanced. Note that as long as the damper film 124 can be formed, the method for forming the damper film 124 is not particularly limited.

As shown in FIG. 6G, a second reservoir portion 124a is formed from an upper surface of the damper film 124 to a lower surface thereof.

As shown in FIG. 6H, the upper surface of the damper film 124 and the lower surface of the fifth substrate 105 are bonded via a first adhesive 152 in the state where the position of the second reservoir portion 124a and the position of the first reservoir portion 105a are aligned. In this way, a bonded substrate including the supporting substrate 106, the damper film 124, and the fifth substrate 105 is formed.

As shown in FIG. 6I, the supporting substrate 106 is removed from the bonded substrate including the fifth substrate 105 and the supporting substrate 106. At the time of removing the supporting substrate 106, the oxide film 151 functions as a stop layer. All the supporting substrate 106 can be removed by grinding and thinning the supporting substrate 106, and performing dry etching or wet etching on the thinned supporting substrate 106 while causing the oxide film 151 to function as a stop layer. In the case of performing dry etching or wet etching on the supporting substrate 106, it is preferable to use a method that has a selection ratio to the oxide film 151. This is for allowing the oxide film 151 which protects the damper film 124 to remain after the supporting substrate 106 is removed. In this way, a bonded substrate in which the oxide film 151, the damper film 124, the first adhesive 152, and the fifth substrate 105 are laminated in this order is formed.

As shown in FIG. 6J, the oxide film 151 which is formed on the lower surface of the damper film 124 is removed by etching. Example of the method for removing the oxide film 151 include dry etching, wet etching, and the like. However, wet etching with which etching stops is preferable to dry etching in consideration of protecting the damper film 124.

As shown in FIG. 6K, a fourth substrate 104 is prepared.

As shown in FIG. 6L, first, an upper portion of a common supply flow passage 125a, a connection flow passage 132, an upper portion of a third reservoir portion 104a, an upper portion of a common recovery flow passage 125b, and a discharge flow passage 125c are formed from an upper surface of the fourth substrate 104 toward a lower surface thereof. Next, a lower portion of the common supply flow passage 125a, a lower portion of the third reservoir portion 104a, and a lower portion of the common recovery flow passage 125b are formed from the lower surface of the fourth substrate 104 toward the upper surface thereof. In this way, the common supply flow passage 125a, the third reservoir portion 104a, and the common recovery flow passage 125b which penetrate a main body of the fourth substrate 104 in the Z-direction are formed in the fourth substrate 104. Then, the connection flow passage 132 and the discharge flow passage 125c which are depressed from the upper surface of the fourth substrate 104 toward the lower surface thereof are formed in a connection portion 126 of the fourth substrate 104.

As shown in FIG. 6M, a second adhesive 153 is applied to the upper surface of the fourth substrate 104. Note that the second adhesive 153 can be applied by the same method as that for the first adhesive 152 (see FIG. 6C).

As shown in FIG. 6N, the lower surface of the damper film 124 is bonded to the upper surface of the fourth substrate 104 via the second adhesive 153 in the state where the positions of the first reservoir portion 105a, the second reservoir portion 124a, and the third reservoir portion 104a are aligned. In this way, a first laminate 171 is formed.

As shown in FIG. 6O, a third adhesive 154 is applied to a lower surface of the first laminate 171 (specifically, the fourth substrate 104). Note that the third adhesive 154 can be applied by the same method as that for the first adhesive 152 (see FIG. 6C) and the second adhesive 153 (see FIG. 6M).

As shown in FIG. 6P, a second laminate 172 is prepared. In the second laminate 172, an ejection port 130 is formed in a first substrate 101 by etching. A vibration plate 131 is formed in an upper surface of the second substrate 102 by etching. As the material of the vibration plate 131, a silicon oxide film or the like can be employed. A piezoelectric element 129 is provided on an upper surface of the vibration plate 131. The main component of the material for forming the piezoelectric element is a polycrystalline ferroelectric ceramic. Examples of the material of the piezoelectric element include barium titanate (BaTiO₃), lead zirconate titanate (PZT), and the like. An individual supply flow passage 127a, a housing space 135, and an individual recovery flow passage 127b are formed in a third substrate 103 by etching.

As shown in FIG. 6Q, an upper surface of the second laminate 172 and a lower surface of the first laminate 171 are bonded via the third adhesive 154. At the time of bonding the upper surface of the second laminate 172 and the lower surface of the first laminate 171, the position of the individual supply flow passage 127a and the position of the common supply flow passage 125a, as well as, the position of the individual recovery flow passage 127b and the position of the common recovery flow passage 125b are aligned. In this way, a liquid ejection substrate 2 is manufactured.

### Manufacturing Method

Hereinafter, Example of the method for manufacturing the first laminate 171 will be described. The following description corresponds to the respective steps from FIG. 6A to FIG. 6N mentioned above.

First, a silicon substrate which could be used as the fifth substrate 105 (see FIG. 6A) was prepared. The diameter of the silicon substrate prepared as the fifth substrate 105 was 200 mm, and the thickness thereof was 625 μm.

Next, a photosensitive positive-type resist was applied to an upper surface of the fifth substrate 105 (see FIG. 6B). At the time of applying the photosensitive positive-type resist to the upper surface of the fifth substrate 105, a predetermined pattern was formed.

Opening portions (depressed portions) and a through hole can be formed in the fifth substrate 105 by combining publicly-known photolithography and publicly-known etching. For example, opening portions can be formed in the fifth substrate 105 by forming a mask on the fifth substrate 105 by using a resist or the like, and thereafter processing the fifth substrate 105 with plasma etching using SF6 gas to etch silicon.

In the case of forming a through hole in the fifth substrate 105, etching is performed on both of the upper surface and a lower surface of the fifth substrate 105. Then, a through hole can be formed by connecting depressed portions formed to face each other respectively from the upper surface and the lower surface in the fifth substrate 105 in such a manner as to pierce bottoms of the depressed portions.

In the present embodiment, exposure was performed on the applied resist through an exposure mask for forming air communication ports 122 and an introduction port 120, with an exposure dose of 4800 mJ/m² by using a semiconductor exposure apparatus. Then, a resist pattern layer was formed through development by using a TMAH aqueous solution. Moreover, etching and passivation were repeated by alternately using SF6 gas and C4F8 gas.

Specifically, the air communication ports 122 and the introduction port 120 were formed by performing etching on the upper surface of the fifth substrate 105 to predetermined positions by reactive ion etching of the Bosch process, which was capable of anisotropic etching.

Then, a first reservoir portion 105a and depressed portions 123 were formed by performing patterning and etching to predetermined positions on the lower surface of the fifth substrate 105 by the same method as the method performed on the upper surface.

In this way, a through hole including the air communication ports 122 and the depressed portions 123 and a through hole including the introduction port 120 and the first reservoir portion 105a were formed in the fifth substrate 105.

Note that the first substrate 101 to the fourth substrate 104 (see FIG. 4 and the like) are also silicon substrates. Hence, opening portions and through holes can be formed also in the first substrate 101 to the fourth substrate 104 in the same manner as in the fifth substrate 105 by combining publicly-known photolithography and publicly-known etching.

Next, a first adhesive 152 (see FIG. 6C) applied to a film was transferred and applied to the lower surface of the fifth substrate 105. The thickness of a layer formed of the first adhesive 152 formed on the lower surface of the fifth substrate 105 was 2μm.

Examples of the method for applying the first adhesive 152 include a method using a dispenser, application by screen printing, a method in which a joining member formed into a dry film is transferred and applied, and the like.

Note that the second adhesive 153 (see FIG. 6M) and the third adhesive 154 (see FIG. 6O) can also be applied by the same method as that for the first adhesive 152.

It is preferable that the material of the first adhesive 152 contain any one resin selected from the group consisting of acrylic resin, epoxy resin, silicone resin, benzocyclobutene resin, polyamide resin, polyimide resin, and urethane resin. In order to obtain higher joint strength, it is more preferable that the material of the first adhesive 152 contain benzocyclobutene resin.

Note that the material of the second adhesive 153 and the material of the third adhesive 154 may also be the same material as that of the first adhesive 152.

Next, a silicon substrate which can be used as the supporting substrate 106 (see FIG. 6D) was prepared. The diameter of the supporting substrate 106 was 200 mm, and the thickness thereof was 725 μm.

Next, an oxide film 151 (see FIG. 6E) was formed on an upper surface of the supporting substrate 106 by a CVD film formation method. The thickness of the oxide film 151 was 500 nm.

Next, polyimide was spin-coated on an upper surface of the oxide film 151. This polyimide can be used as the material of a damper film 124 (see FIG. 6F). The damper film 124 having a thickness of 3 μm was formed on the upper surface of the oxide film 151 by setting the temperature of a clean oven to 350 ° C. and baking the polyimide, which was applied to the oxide film 151, by using this clean oven.

Next, a second reservoir portion 124a (see FIG. 6G) was formed by forming an etching mask on an upper surface of the damper film 124 by using a positive-type photoresist, and performing etching by using a mixed gas containing O2 gas and CF4 gas.

Next, the upper surface of the damper film 124 and the lower surface of the fifth substrate 105 were bonded via the first adhesive 152 (see FIG. 6H).

Next, the supporting substrate 106 was thinned from the lower surface of the supporting substrate 106 toward the upper surface thereof until the thickness of the supporting substrate 106 became 50 μm by using a back grinding apparatus. Then, dry etching was further performed on the thinned supporting substrate 106 by using SF6 gas, so that the oxide film 151 (see FIG. 6I) was exposed.

Next, the oxide film 151 was removed by using a BHF (buffered hydrofluoric acid solution), so that the damper film 124 (see FIG. 6J) was exposed.

Next, a silicon substrate which can be used as the fourth substrate 104 (see FIG. 6K) was prepared. The diameter of the fourth substrate 104 was 200 mm, and the thickness thereof was 625 μm.

Next, a common supply flow passage 125a, a connection flow passage 132, an introduction port 120, a common recovery flow passage 125b, and a discharge flow passage 125c were formed in the fourth substrate 104 (see FIG. 6L).

Specifically, a predetermined pattern was formed on an upper surface of the fourth substrate 104, and a photosensitive positive-type resist was applied to the upper surface of the fourth substrate 104. Exposure was performed on the applied resist through an exposure mask for forming an upper portion of the common supply flow passage 125a, an upper portion of the introduction port 120, and an upper portion of the common recovery flow passage 125b, with an exposure dose of 4800 mJ/m² by using a semiconductor exposure apparatus.

Moreover, a resist pattern layer was formed through development by using a TMAH aqueous solution. Moreover, etching and passivation were repeated by alternately using SF6 gas and C4F8 gas. Moreover, the silicon substrate was etched to predetermined positions by reactive ion etching of the Bosch process, which was capable of anisotropic etching. For example, the connection flow passage 132 was formed by performing predetermined patterning on an upper surface of the connection portion 126 of the fourth substrate 104, and etching the main body of the fourth substrate 104 to a position where the etching did not penetrate the main body of the fourth substrate 104 in the height direction. In this way, the upper portion of the common supply flow passage 125a, the connection flow passage 132, the upper portion of the introduction port 120, the upper portion of the common recovery flow passage 125b, and the discharge flow passage 125c were formed.

Then, a lower portion of the common supply flow passage 125a, a lower portion of the introduction port 120, and a lower portion of the common recovery flow passage 125b were formed. These were formed by performing patterning and etching to predetermined positions on the lower surface of the fourth substrate 104 by the same method as the method performed on the upper surface of the fourth substrate 104.

Next, a second adhesive 153 (see FIG. 6M) was applied to the upper surface of the fourth substrate 104.

Next, the upper surface of the fourth substrate 104 and a lower surface of the damper film 124 were bonded via the second adhesive 153 (see FIG. 6N).

The specific method for manufacturing the first laminate 171 is as described above.

As described above, in the liquid ejection substrate 2 of the present embodiment, once the liquid is taken in from one introduction port 120, the liquid is supplied from one reservoir 121, which is connected to the one introduction port 120, to one common supply flow passage 125a via a plurality of connection flow passages 132. At the time when the liquid is supplied from one reservoir 121 to one common supply flow passage 125a, the flow of the liquid is regulated by the connection portion 126.

In the present embodiment, the liquid which has flowed from the reservoir 121 collides with the wall of the connection portion 126, so that the flow velocity decreases. According to this configuration, the liquid can be distributed into the plurality of connection flow passages 132, which are disposed along the first direction (the X-direction), in the state where the flow velocities of the liquid flowing out from one reservoir 121 are made uniform to a some extent.

Hence, in the state where variation, in the first direction, in flow velocity of the liquid to be supplied in the second direction is reduced, the liquid can be supplied from the plurality of connection flow passages 132 to one common supply flow passage 125a which extends in the first direction. Then, the liquid is supplied from the one common supply flow passage 125a to the plurality of individual supply flow passages 127a which are disposed along the first direction. Moreover, in the state where the flow velocities are made uniform, the liquid is supplied to each of the plurality of individual supply flow passages 127a.

Therefore, according to the liquid ejection substrate of the present embodiment, a liquid can be uniformly distributed to a plurality of individual flow passages.

Thereafter, the liquid is supplied to the pressure chambers 128 and the ejection ports 130 via the individual supply opening portions 131a. According to this configuration, in the case of supplying the liquid from one introduction port 120 to a plurality of ejection ports 130, the stagnation of the flow of the liquid is alleviated at the connection portion 126, and the liquid can be supplied at equivalent flow velocities to all the ejection ports 130.

Hence, the liquid can be supplied equivalently to all the ejection ports 130 irrespective of positions in the X-direction. As a result, differences in ejection amount of the liquid among a plurality of ejection ports can be reduced, and thus, an image with no density unevenness can be printed on a printing medium.

### Modification of Manufacturing Method

Hereinafter, Modification of the above-mentioned manufacturing method will be described with reference to the drawings. In the following description, configurations which are the same as or correspond to those in the above-mentioned manufacturing method are denoted by the same signs, and descriptions thereof are omitted, and different points are mainly described.

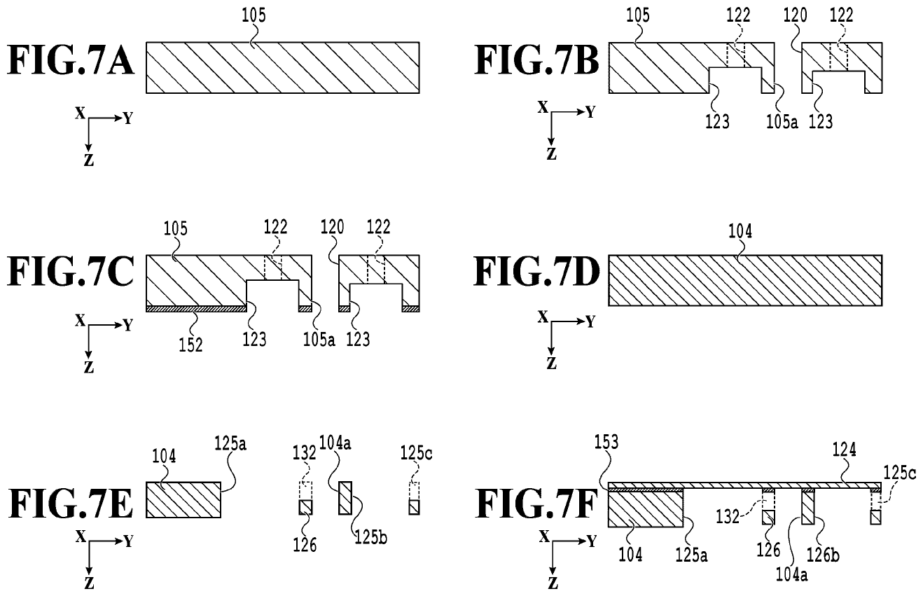

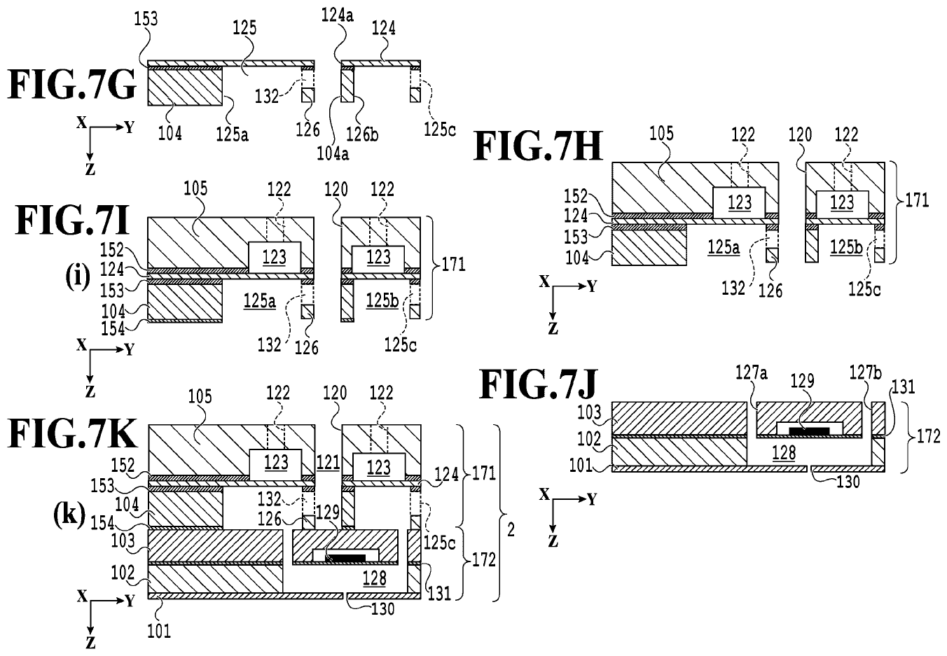

FIG. 7A to FIG. 7K are diagrams showing Modification of the method for manufacturing the liquid ejection substrate 2.

As shown in FIG. 7A, a fifth substrate 105 is prepared.

As shown in FIG. 7B, air communication ports 122, depressed portions 123, an introduction port 120, and a first reservoir portion 105a are formed in the fifth substrate 105.

As shown in FIG. 7C, a first adhesive 152 is applied to a lower surface of the fifth substrate 105.

As shown in FIG. 7D, a fourth substrate 104 is prepared. Note that in the example of FIG. 6D, the supporting substrate 106 was prepared. However, in the manufacturing method of the present embodiment, a liquid ejection substrate 2 (see FIG. 7K) can be manufactured even without using the supporting substrate 106.

As shown in FIG. 7E, a common supply flow passage 125a, a connection portion 126, a connection flow passage 132, a third reservoir portion 104a, a common recovery flow passage 125b, and a discharge flow passage 125c are formed in the fourth substrate 104.

As shown in FIG. 7F, a damper film 124 is formed on an upper surface of the fourth substrate 104 by using a second adhesive 153. The material of the damper film 124 is preferably polyimide or the like. An example of the method for forming the damper film 124 on the upper surface of the fourth substrate 104 includes a method including: applying the second adhesive 153 to the upper surface of the fourth substrate 104, and pasting a polyimide tape to the upper surface of the second adhesive 153. Another example includes a method including: applying the second adhesive 153 to the upper surface of the fourth substrate 104; and transferring a polyimide film which is formed on a dry film to an upper surface of the second adhesive 153.

As shown in FIG. 7G, a second reservoir portion 124a is formed in the damper film 124. The second reservoir portion 124a can be formed by resist patterning with photolithography and dry etching using O2 gas, O2CF4 mixed gas or the like.

As shown in FIG. 7H, an upper surface of the damper film 124 and a lower surface of the fifth substrate 105 are bonded by using a first adhesive 152. In this way, a first laminate 171 is formed.

As shown in FIG. 7I, a third adhesive 154 is applied to a lower surface of the fourth substrate 104.

As shown in FIG. 7J, a second laminate 172 is prepared.

As shown in FIG. 7K, an upper surface of the second laminate 172 and a lower surface of the first laminate 171 are bonded by using the third adhesive 154. In this way, a liquid ejection substrate 2 is formed.

The liquid ejection substrate 2 which can suppress a decrease in image quality can be manufactured by such a method as well. Moreover, according to the manufacturing method of the present embodiment, since the supporting substrate 106 is not used, the number of steps can be reduced as compared with the manufacturing method of the first embodiment.

### Second Embodiment

Hereinafter, a second embodiment in the technology of the present disclosure will be described with reference to the drawings. In the following description, configurations which are the same as or corresponding to those in the first embodiment are denoted by the same signs, and descriptions thereof are omitted, and different points are mainly described. An object of the present embodiment is to provide a liquid ejection substrate which can more firmly support a damper film.

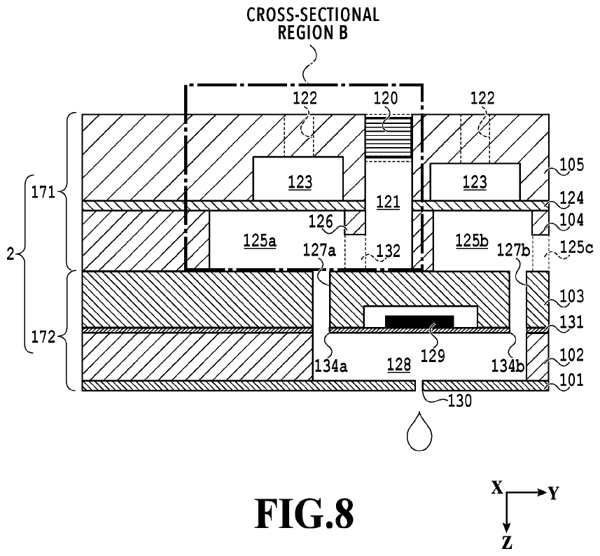

FIG. 8 is an enlarged view of a vicinity of an ejection port 130 applicable to the present embodiment.

As shown in FIG. 8, in the present embodiment, a connection flow passage 132 is formed in such a manner as to be depressed from a lower surface of a connection portion 126 toward an upper surface thereof in the state where a first laminate 171 and a second laminate 172 are bonded.

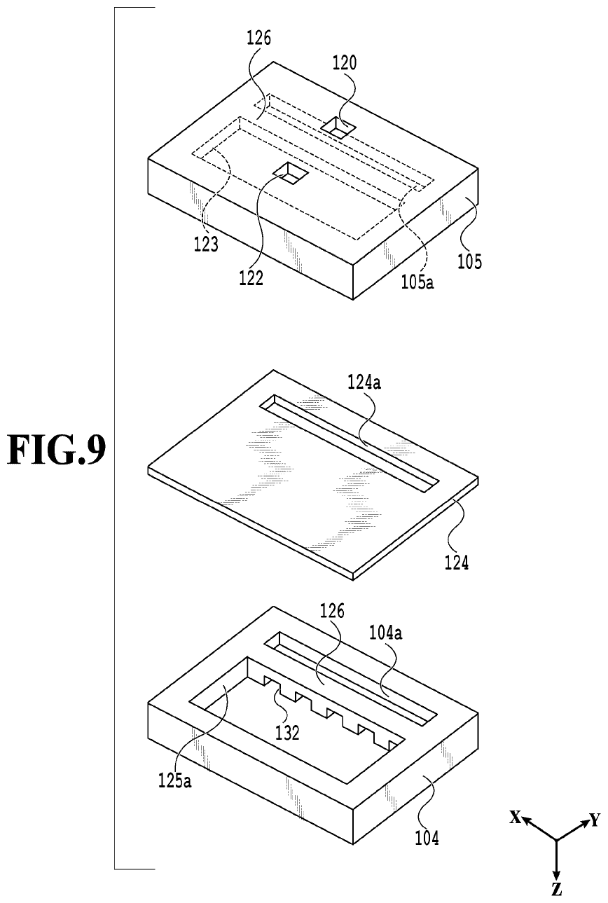

FIG. 9 is an exploded perspective view of a cross-sectional region B shown in FIG. 8.

As shown in FIG. 9, in the present embodiment, the connection flow passages 132 are not formed in a bonding surface where the connection portion 126 and the damper film 124 (see FIG. 7 and the like) are bonded. In the connection portion 126 of the present embodiment, a plurality of connection flow passages 132 which are depressed from the lower surface toward the upper surface are formed along the longitudinal direction (the X-direction). According to this configuration, the bonding area between the upper surface of the connection portion 126 and the lower surface of the damper film 124 becomes larger than that in the first embodiment. As a result, the adhesion between the fourth substrate 104 and the damper film 124 is improved as compared with the first embodiment.

Therefore, according to the liquid ejection substrate of the present embodiment, a damper film can be more firmly supported.

### Third Embodiment

Hereinafter, a third embodiment in the technology of the present disclosure will be described with reference to the drawings. In the following description, configurations which are the same as or correspond to those in the first and second embodiments are denoted by the same signs, and descriptions thereof are omitted, and different points are mainly described. An object of the present embodiment is to provide a liquid ejection substrate which can more firmly support a damper film.

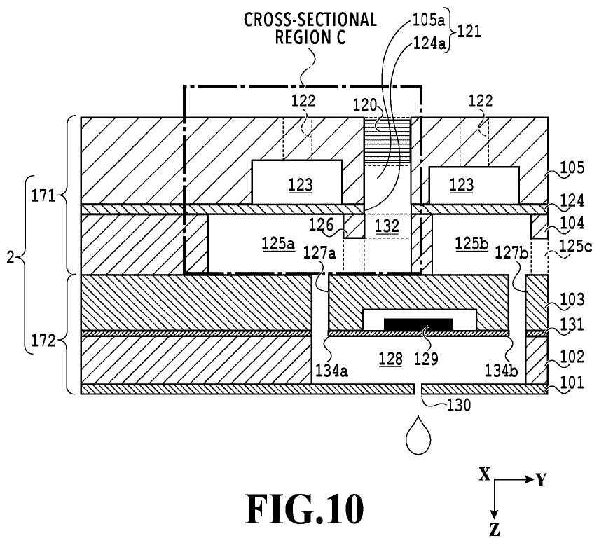

FIG. 10 is an enlarged view of a vicinity of an ejection port 130 applicable to the present embodiment.

As shown in FIG. 10, in a fourth substrate 104 of the present embodiment, a third reservoir portion 104a is not formed. In the fourth substrate 104 of the present embodiment, a connection portion 126 is directly connected to a reservoir 121. The connection portion 126 includes: a plurality of connection flow passages 132; and a region which connects the plurality of connection flow passages 132 in common to a common supply flow passage 125a in the Y-direction. Each connection flow passage 132 includes: an opening which is connected to the reservoir 121; and a flow passage which extends in the Z-direction. The reservoir 121 of the present embodiment includes a first reservoir portion 105a and a second reservoir portion 124a.

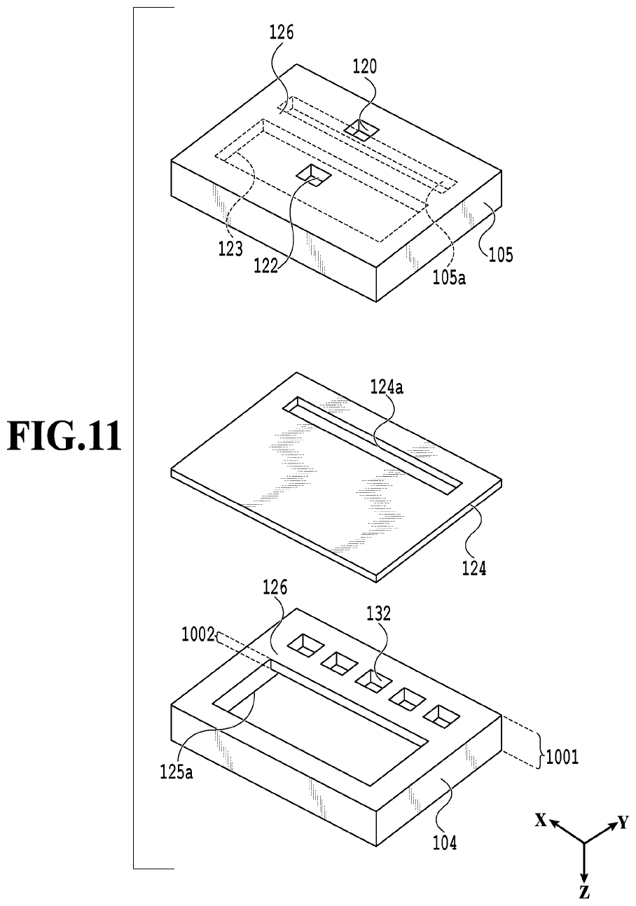

FIG. 11 is an exploded perspective view of a cross-sectional region C shown in FIG. 10.

As shown in FIG. 11, in the present embodiment, each connection flow passage 132 includes an opening portion which is connected to the second reservoir portion 124a, and each of these opening portions is connected to a flow passage which extends in the first direction (the X-direction).

Each of the plurality of opening portions is connected to one second reservoir portion 124a in the state where an upper surface of the fourth substrate 104 and a lower surface of the damper film 124 are bonded.

In addition, in the present embodiment, a thick portion 1001 and a thin portion 1002 whose size is smaller in the height direction than the thick portion 1001 are formed in the fourth substrate 104. Then, the opening portions of the plurality of connection flow passages 132 are formed in such a manner as to penetrate the main body of the thin portion 1002 from an upper surface of the thin portion 1002 toward a lower surface thereof. According to this configuration, the bonding area between the upper surface of the fourth substrate 104 and the lower surface of the damper film 124 becomes larger than that in the second embodiment.

Therefore, according to the liquid ejection substrate of the present embodiment a damper film can be more firmly supported than the second embodiment.

### Fourth Embodiment

Hereinafter, a fourth embodiment in the technology of the present disclosure will be described with reference to the drawings. In the following description, configurations which are the same as or correspond to those in the first, second, and third embodiments are denoted by the same signs, and descriptions thereof are omitted, and different points are mainly described. An object of the present embodiment is to provide a liquid ejection substrate which can firmly support a damper film and ensure a rigidity of a connection portion.

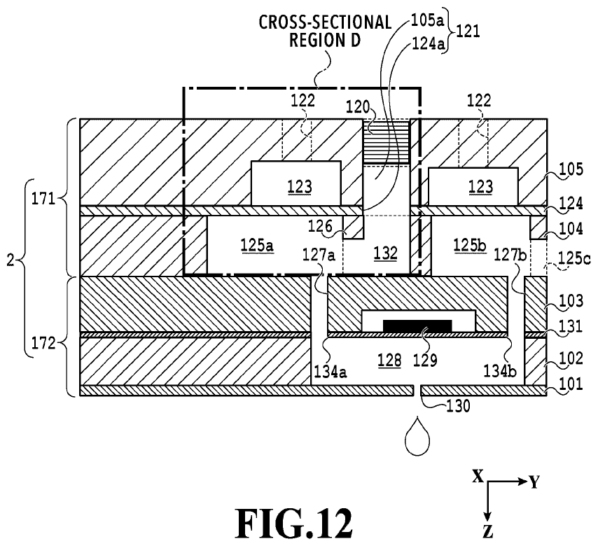

FIG. 12 is an enlarged view of a vicinity of an ejection port 130 applicable to the present embodiment.

As shown in FIG. 12, in the present embodiment as well, a third reservoir portion 104a (see FIG. 4 and the like) is not formed like in the third embodiment.

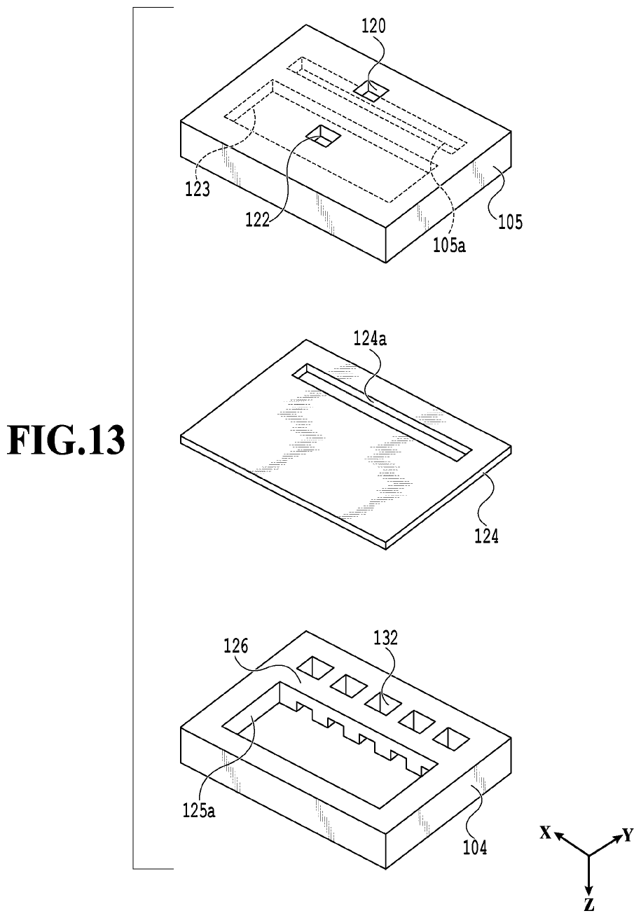

FIG. 13 is an exploded perspective view of a cross-sectional region D shown in FIG. 12.

As shown in FIG. 13, in the present embodiment, each connection flow passage 132 includes: an opening portion which is connected to a second reservoir portion 124a; a region which extends from this opening portion in the Z-direction; and a region which extends from the above region in the Y-direction and is connected to a common supply flow passage 125a. In a fourth substrate 104 of the present embodiment, a plurality of opening portions which are arrayed in the X-direction; and a plurality of flow passages which are connected to the respective opening portions and each have a portion extending in the Z-direction and a portion extending in the Y-direction are formed. According to this configuration, the thickness of a connection portion 126 is increased, so that the rigidity of the connection portion 126 is improved, as compared with the third embodiment. In addition, since the flow passage length of each connection flow passage is longer than in the above-described embodiments, the effect to reduce variation, in the first direction, in flow velocity can be further enhanced.

In addition, the bonding area between the upper surface of the fourth substrate 104 and the lower surface of the damper film 124 is ensured like in the third embodiment.

Therefore, according to the liquid ejection substrate of the present embodiment, a damper film can be firmly supported, and the rigidity of a connection portion can be ensured.

### Fifth Embodiment

Hereinafter, a fifth embodiment in the technology of the present disclosure will be described with reference to the drawings. In the following description, configurations which are the same as or correspond to those in the first, second, third, and fourth embodiments are denoted by the same signs, and descriptions thereof are omitted, and different points are mainly described. An object of the present embodiment is to provide a liquid ejection substrate which can suppress a decrease in image quality.

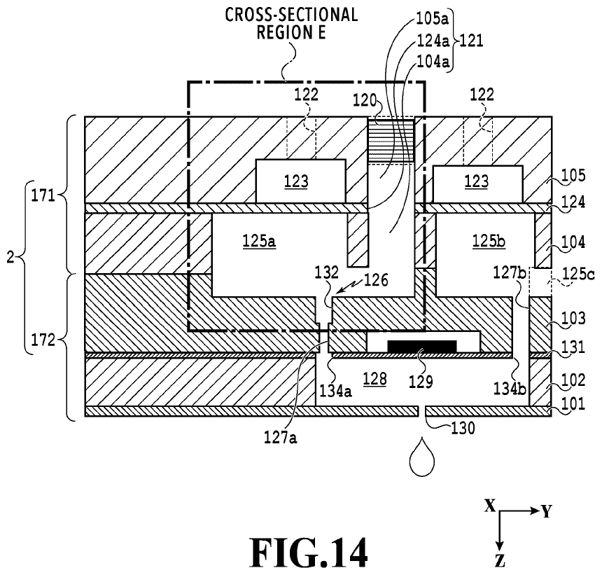

FIG. 14 is an enlarged view of a vicinity of an ejection port 130 applicable to the present embodiment.

As shown in FIG. 14, a connection portion 126 of the present embodiment is formed in a third substrate 103. A connection flow passage 132 is formed in such a manner as to be depressed from an upper surface of the third substrate 103 toward a lower surface thereof in the state where the upper surface of the third substrate 103 and a lower surface of a fourth substrate 104 are bonded. That is, the connection portion 126 of the present embodiment is provided between a common supply flow passage 125a and an individual supply flow passage 127a.

An opening on the upper surface side of the connection flow passage 132 is connected to a third reservoir portion 104a and the common supply flow passage 125a in the state where the upper surface of the third substrate 103 and the lower surface of the fourth substrate 104 are bonded. The individual supply flow passage 127a is formed in such a manner as to extend from a bottom surface of the connection flow passage 132 toward the lower surface of the third substrate 103 in the state where the lower surface of the third substrate 103 and the upper surface of the vibration plate 131 are bonded.

According to this configuration, it becomes possible to reduce, between the common supply flow passage and the individual supply flow passage, variation in flow velocity of the liquid supplied from a reservoir 121, and make uniform the flow velocities of the liquid supplied respectively to the plurality of individual supply flow passages 127a. In this way, the connection flow passage 132 of the present embodiment has a function of regulating the flow of the liquid.

Note that in the present embodiment, a discharge flow passage 125c is formed in the third substrate 103. Hence, in the present embodiment, the liquid is discharged from the third substrate 103 to the outside.

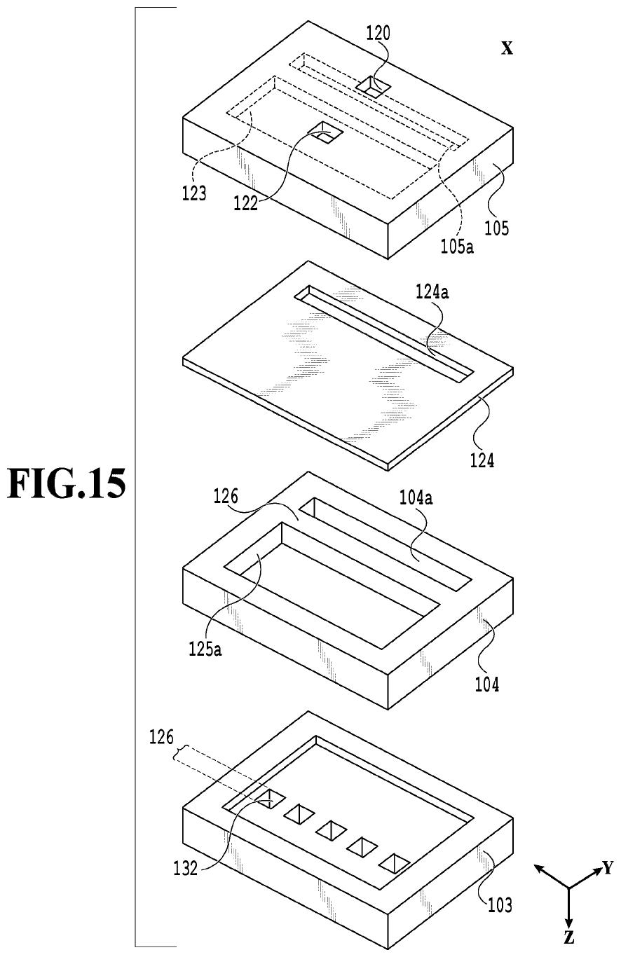

FIG. 15 is an exploded perspective view of a cross-sectional region E shown in FIG. 14.

As shown in FIG. 15, the connection portion 126 of the present embodiment is formed in the third substrate 103. That is, the plurality of connection flow passages 132 included in the connection portion 126 are formed between the common supply flow passage 125a and a plurality of individual supply flow passages in a circulation direction.

In addition, openings of the plurality of individual supply flow passages 127a are formed in the bottom surfaces of the connection flow passages 132 along the first direction. In this way, in the present embodiment, the liquid is distributed from one supply flow passage (one reservoir 121 and one connection flow passage 132) to each of the plurality of individual supply flow passages 127a in the bottom surfaces of the connection flow passages 132.

As described above, in the liquid ejection substrate of the present embodiment, the flow velocities of the liquid taken in from one introduction port 120 are adjusted by the connection flow passages 132. Then, the liquid is supplied to the pressure chambers 128 via the pluralities of individual supply flow passages 127a and individual supply opening portions 131a. According to this configuration, the stagnation of the flow of the liquid in the case where the liquid is supplied from one introduction port 120 to a plurality of pressure chambers 128 is alleviated, so that the liquid can be supplied at equivalent flow velocities to all the pressure chambers 128. Hence, it thus becomes possible to eliminate differences in supply amount of the liquid to the pressure chambers 128 in the case of ejecting the liquid, and to eject the liquid in the same amount from all the ejection ports 130.

Therefore, according to the liquid ejection head having such a configuration as well, a decrease in image quality can be suppressed.

### Sixth Embodiment

Hereinafter, a sixth embodiment in the technology of the present disclosure will be described with reference to the drawings. In the following description, configurations which are the same as or correspond to those in the first, second, third, fourth, and fifth embodiments are denoted by the same signs, and descriptions thereof are omitted, and different points are mainly described.

An object of the present embodiment is to provide a liquid ejection substrate which can suppress a decrease in image quality.

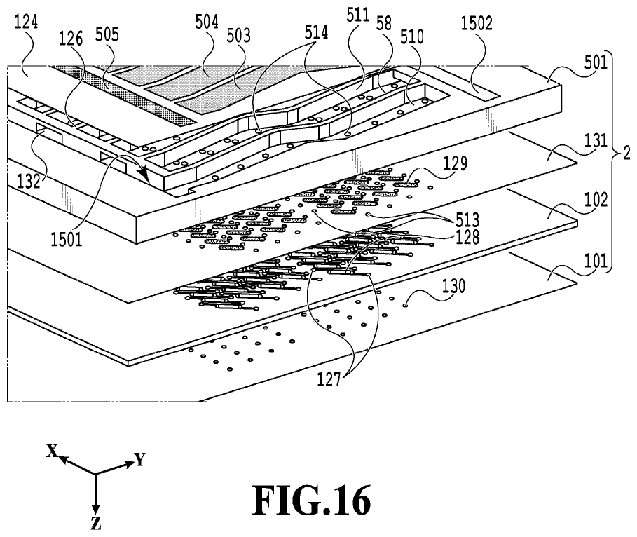

FIG. 16 is an exploded perspective view of a liquid ejection substrate 2 applicable to the present embodiment. In FIG. 16, the fifth substrate 105 (see FIG. 4 and the like) is not shown for the sake of convenience of the description.

As shown in FIG. 16, in the liquid ejection substrate 2 of the present embodiment, a first substrate 101, a second substrate 102, a vibration plate 131, a common flow passage member 501, and a damper film 124 are laminated in this order. In the first substrate 101, ejection ports 130 are formed. In the second substrate 102, a plurality of pressure chambers 128 and pluralities of individual supply flow passages 127a and individual recovery flow passages 127b are formed. In the vibration plate 131, piezoelectric elements 129 are provided.

In the vibration plate 131 of the present embodiment, a plurality of first through holes 513 which penetrate the vibration plate 131 in the height direction in the state where the vibration plate 131 is sandwiched between the second substrate 102 and the common flow passage member 501 are formed. Each of the plurality of first through holes 513 is connected to a corresponding one of the plurality of individual supply flow passages 127a or individual recovery flow passages 127b, which are formed in the second substrate 102, in the state where an upper surface of the first substrate 101 and a lower surface of the second substrate 102 are bonded. In the present embodiment, parts of the individual supply flow passages 127a or the individual recovery flow passages 127b are formed in this way.

The common flow passage member 501 has a function of the third substrate 103 and a function of the fourth substrate 104 (see FIG. 4 and the like). In the common flow passage member 501, one first common supply flow passage 1501, a plurality of second common supply flow passages 510, one first common recovery flow passage 1502, and a plurality of second common recovery flow passages 511 are formed. The first common supply flow passage 1501 and the first common recovery flow passage 1502 extend along the longitudinal direction (the X-direction) of the common flow passage member 501.

The plurality of second common supply flow passages 510 are connected to the one first common supply flow passage 1501 via connection flow passages 132 which are formed in a connection portion 126, and extend along the transverse direction (the Y-direction) of the common flow passage member 501. The plurality of second common recovery flow passages 511 are connected to the one first common recovery flow passage 1502 via the connection flow passages 132 which are formed in the connection portion 126, and extend along the transverse direction (the Y-direction) of the common flow passage member 501.

The plurality of second common supply flow passages 510 and the plurality of second common recovery flow passages 511 are alternately arranged along the longitudinal direction (the X-direction) of the common flow passage member 501. The second common supply flow passage 510 and the second common recovery flow passage 511 adjacent thereto are separated by a partition wall 58.

In bottom portions of the second common supply flow passages 510 and bottom portions of the second common recovery flow passages 511, second through holes 514 which penetrate these bottom portions in the height direction in the state where the upper surface of the vibration plate 131 and the lower surface of the common flow passage member 501 are bonded are formed. In the present embodiment, parts of the individual supply flow passages 127a or the individual recovery flow passages 127b are formed in this way.

The first through holes 513 are connected to the second through holes 514 in the state where the upper surface of the vibration plate 131 and the lower surface of the common flow passage member 501 are bonded. This make it possible to supply the liquid from the second through holes 514 to the first through holes 513, and recover the liquid from the first through holes 513 to the second through holes 514 at other positions. To the upper surface of the common flow passage member 501, the lower surface of the damper film 124 is bonded.

A filter 505 which traps dust and the like contained in the liquid supplied to the first common supply flow passage 1501 in the state where the upper surface of the common flow passage member 501 and the lower surface of the damper film 124 are bonded is formed in the damper film 124. The second common supply flow passages 510 are sealed by first damper regions 503, which are provided in the damper film 124, in the state where the upper surface of the common flow passage member 501 and the lower surface of the damper film 124 are bonded.

The second common supply flow passage 510 and the first damper region 503 have the same shape in the state where the upper surface of the common flow passage member 501 and the upper surface of the damper film 124 are viewed in plan view. The second common recovery flow passages 511 are sealed by second damper regions 504, which are provided in the damper film 124, in the state where the upper surface of the common flow passage member 501 and the periphery of the lower surface of the damper film 124 are bonded. The second common recovery flow passages 511 have the same shape in the state where the upper surface of the common flow passage member 501 and the upper surface of the damper film 124 are viewed in plan view.

In addition, in the fifth substrate 105 (not sown in FIG. 16) of the present embodiment, openings which have the same shape as the first damper regions 503 and openings which have the same shape as the second damper regions 504 are formed. This makes it possible for the first damper regions 503 and the second damper regions 504 to deflect in the height direction in the state where the damper film 124 is sandwiched between the common flow passage member 501 and the fifth substrate 105.

In order to efficiently obtain a vibration suppressing effect (damper effect) of the liquid, it is unfavorable that a wrinkle is generated in the first damper regions 503 and the second damper regions 504. In addition, it is also unfavorable that the damper film 124 is peeled off from the common flow passage member 501. In view of this, in the present embodiment, the connection flow passages 132 are formed such that the openings of the connection flow passages 132 are directed to the side surface of the common flow passage member 501 (in the −Y-direction in the drawing).

According to this configuration, it becomes possible to let out, in the −Y-direction, pressure, which is transferred in conjunction with the ejecting operation from the ejection ports 130, and to thus reduce pressure which the first damper regions 503 and the second damper regions 504 receive in the +Z-direction.

A pressure fluctuation which is generated at the time of ejecting the liquid can be efficiently reduced by efficiently obtaining the vibration suppressing effect (damper effect) in this way. In turn, the liquid can be stably supplied to the pressure chambers 128.

According to the present embodiment, a configuration in which the connection portion 126 including the plurality of connection flow passages 132 is provided between the first common supply flow passage 1501 and the second common supply flow passages 510 is obtained. In addition, a configuration in which the connection portion 126 including the plurality of connection flow passages 132 is provided between the first common recovery flow passage 1502 and the second common recovery flow passages 511 is obtained. This makes it possible to make uniform the speed of supplying the liquid to the plurality of second common supply flow passages 510, which are arranged side by side in the X-direction.

Therefore, according to the liquid ejection substrate of the present embodiment, a decrease in image quality can be suppressed.

### Other Embodiments

Although in the above embodiments, the connection portion and the connection flow passages are formed in the supply flow passages, the connection portion and connection flow passages may be formed in the recovery flow passages. This configuration also allows the flow velocity to be adjusted.

In the above embodiments, the piezoelectric elements 129 (see FIG. 4 and the like) are used as the energy generation elements. However, an element which can be used as the energy generation element is not limited to a piezoelectric element. A heater which changes pressure inside a pressure chamber by heating can also be used as the energy generation element. Note that in the case of using a heater as the energy generation element, there is no need to provide the vibration plate 131 (see FIG. 4 and the like).

In addition, in this case, the second substrate 102 and the third substrate 103 (see FIG. 4 and the like) may be directly bonded.

In the above embodiments, silicon is used as the material of the first substrate 101 to the fifth substrate 105 and the supporting substrate 106. However, as long as an elastic modulus is equal to or more than that of silicon, the material which can be used as the material of the first substrate 101 to the fifth substrate 105 and the supporting substrate 106 is not limited to silicon.

Other examples of the material which can be used as the material of the first substrate 101 to the fifth substrate 105 and the supporting substrate 106 include silicon carbide and silicon nitride. Moreover, other examples include various glasses (quartz glass, borosilicate glass, non-alkaline glass, soda glass, and the like) and various ceramics (alumina, cermet, boron carbide, zirconia, mullite, gallium nitride, aluminum nitride, and the like). In the case where the first substrate 101 to the fifth substrate 105 and the supporting substrate 106 are formed of any of these materials as well, it is possible to avoid a problem due to deformation.

According to the liquid ejection substrate of the present disclosure, a liquid can be uniformly distributed to a plurality of individual flow passages.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-204671, filed Nov. 25, 2024, which is hereby incorporated by reference herein in its entirety.

What is claimed is:

1. A liquid ejection substrate comprising:
a plurality of ejection ports;
a plurality of pressure chambers configured to store a liquid to be ejected by the plurality of ejection ports, respectively;
a plurality of energy generation elements configured to generate energy for ejecting the liquid from the ejection ports;
a plurality of individual flow passages configured to supply the liquid to the plurality of pressure chambers, respectively;
a common flow passage configured to supply the liquid to the plurality of individual flow passages in common; and
a damper film provided in such a manner as to face part of the common flow passage, wherein
the plurality of individual flow passages are arranged along a first direction,
the common flow passage extends in the first direction, and supplies the liquid in a second direction intersecting the first direction,
a connection portion in which a plurality of connection flow passages configured to supply the liquid in the second direction are arrayed in the first direction is provided in a middle of the common flow passage, and
the connection portion supports part of the damper film.

2. The liquid ejection substrate according to claim 1, wherein
the connection flow passages are not formed in a bonding surface where the connection portion and the damper film are bonded, and
the connection flow passages are formed in a surface opposite to the bonding surface.

3. The liquid ejection substrate according to claim 1, further comprising an introduction port configured to supply the liquid to the common flow passage from outside.

4. The liquid ejection substrate according to claim 1, wherein a height of the connection flow passages is lower than a height of the common flow passage.

5. The liquid ejection substrate according to claim 1, wherein a length, in the first direction, of the connection flow passages is shorter than a length, in the first direction, of a region other than the connection portion in the common flow passage.

6. The liquid ejection substrate according to claim 1, further comprising:
an individual recovery flow passage connected to the pressure chambers;
a common recovery flow passage connected to the individual recovery flow passage; and
a discharge flow passage connected to the common recovery flow passage, wherein
the liquid which has not been ejected from the ejection ports passes through the individual recovery flow passage, the common recovery flow passage, and the discharge flow passage in this order, and is circulated between the pressure chambers and a pump provided outside the liquid ejection substrate, to be supplied to the common flow passage again.

7. The liquid ejection substrate according to claim 1, wherein
the common flow passage includes a reservoir configured to supply the liquid along a third direction intersecting the first direction and the second direction, and
the connection flow passages are connected to the reservoir.

8. The liquid ejection substrate according to claim 1, wherein
the common flow passage includes a depressed portion, and
the connection flow passages extend along a of direction of the individual flow passages from an opening formed in a bottom surface of the depressed portion.

9. The liquid ejection substrate according to claim 1, wherein the energy generation elements are each a piezoelectric element whose volume changes upon receipt of a predetermined electrical signal.

10. A liquid ejection head comprising a liquid ejection substrate, wherein
the liquid ejection substrate includes:
a plurality of ejection ports;
a plurality of pressure chambers configured to store a liquid to be ejected by the plurality of ejection ports, respectively;
a plurality of energy generation elements configured to generate energy for ejecting the liquid from the ejection ports;
a plurality of individual flow passages configured to supply the liquid to the plurality of pressure chambers, respectively;
a common flow passage configured to supply the liquid to the plurality of individual flow passages in common; and
a damper film provided in such a manner as to face part of the common flow passage, wherein
the plurality of individual flow passages are arranged along a first direction,
the common flow passage extends in the first direction, and is configured to supply the liquid in a second direction intersecting the first direction,
a connection portion in which a plurality of connection flow passages configured to supply the liquid in the second direction are arrayed in the first direction is provided in a middle of the common flow passage, and
the connection portion supports part of the damper film.

11. A method for manufacturing a liquid ejection substrate including a first substrate, a second substrate, a third substrate, a fourth substrate, and a fifth substrate and being configured to eject a liquid, the method comprising the steps of:
forming, in the fifth substrate, an introduction port configured to introduce the liquid and a first reservoir portion connected to the introduction port;
forming, in a damper film having elasticity, a second reservoir portion penetrating the damper film;
aligning positions of the second reservoir portion and the first reservoir portion, and fixing a lower surface of the fifth substrate to an upper surface of the damper film;
forming, in the fourth substrate, a common supply flow passage penetrating the fourth substrate, a third reservoir portion penetrating the fourth substrate, and a connection flow passage connecting the third reservoir portion and the common supply flow passage;
aligning positions of the third reservoir portion and the second reservoir portion, and fixing a lower surface of the damper film to an upper surface of the fourth substrate to form a first laminate including the fourth substrate, the damper film, and the fifth substrate;
preparing a second laminate including the first substrate in which an ejection port configured to eject the liquid is formed, the second substrate in which a pressure chamber connected to the ejection port and configured to receive pressure is formed, and the third substrate including an energy generation element provided at a position corresponding to the ejection port and configured to generate energy for ejecting the liquid, in which an individual flow passage connected to an end portion of the pressure chamber is formed; and
fixing a lower surface of the first laminate to an upper surface of the second laminate, wherein
in the forming the common supply flow passage, the third reservoir portion, and the connection flow passage, a plurality of the connection flow passages are formed along a first direction, and a larger number of the connection flow passages than the number of the introduction ports are formed.
